(19) United States
(12) Patent Application Publication
(10) Pub. No.: US 2005/0057042 A1
(43) Pub. Date: Mar. 17, 2005

(54) Push button bayonet tube connector

(76) Inventor: Jeffrey Clark Wicks, Fort Collins, CO (US)

Correspondence Address: DORSEY & WHITNEY, LLP;INTELLECTUAL PROPERTY DEPARTMENT, 370 SEVENTEENTH STREET, SUITE 4700, DENVER, CO, 80202-5647, US

(21) Appl. No.: 10/940,089

(22) Filed: Sep. 13, 2004

Related U.S. Application Data
(60) Provisional application No. 60/502,500, filed on Sep. 12, 2003.

(51) Int. Cl. H01R 13/28

(52) U.S. Cl. 285/305; 285/308

(57) ABSTRACT

A push button bayonet tube connector assembly for releasably connecting two fluid passageways is described. The bayonet assembly includes a male and female member. The female member includes a spring actuated push button engagement assembly having a locked or engaged position and an unlocked or disengaged position with the male member. A method for fabricating the push button bayonet tube connector assembly is also described.

### CROSS REFERENCE TO RELATED APPLICATIONS

This application claims priority to U.S. Provisional Patent Application No. 60/502,500 titled “Push Button Bayonet Tube Connector,” filed Sep. 12, 2003, which is hereby incorporated by reference herein.

### FIELD OF INVENTION

The invention generally relates to tube connectors, and more particularly to tube connectors having push button release mechanism for releasably connecting two or more sections of tubing.

### BACKGROUND OF INVENTION

Tube connectors have a variety of applications in, for example, the biomedical, pharmaceutical, and light industrial industries. Tube connectors generally are required where some level of control is required over the flow of a fluid within a fluid passageway. Generally, such control is exerted over the fluid by incorporating a tube connector within the path of the tubing.

There are a variety of tube connectors available on the market. One such tube connector is the bayonet connector, which generally has an outer collar that must be pulled back axially to allow a set of ball-bearings to disengage from a groove in the corresponding male member to allow the male member to be removed from the female housing. Over the past several years there has been a move within the relevant art to incorporate tube connectors into smaller diameter tubing, especially with regard to the biomedical industries. As such, there is a need in the art to design and fabricate a bayonet connector for use with smaller diameter tubing.

As tubing diameters reduce in size, bayonet structures need to also reduce in size, making it difficult for a user to grasp the collar and retract it axially. This is especially true if the user's hands are coated in a fluid, such as water, blood, or other materials that can act as possible lubricants. Against this backdrop the following disclosure is provided.

### SUMMARY OF INVENTION

The present invention was developed to allow a user to more easily connect and disconnect the ends of a tubular structure, even when the tubular structure has a small diameter. The present invention provides a reversible connection that couples two or more tubular structures together and is particularly useful when the user has an impaired ability to grasp and manipulate the connector, e.g., when lubricant like fluids or other materials are on the user's hands or the connector.

In one embodiment, the connector assembly is a push button bayonet assembly that includes a female housing defining a channel extending therethrough, the female housing having an engagement assembly, the engagement assembly comprising a top portion, and a ring latch assembly defining an aperture, the engagement assembly movable between a first position and a second position, and biased in the first position; and a male member having a connector shaft with a groove extending at least partially circumferentially around the shaft; and wherein the channel receives the shaft when the engagement assembly is in the second position, and the engagement assembly engages the groove on the shaft when in the first position to retain the shaft in the channel, thereby retaining the male member with the female member.

In another embodiment, the ring latch assembly defines an aperture that has a major axis oriented vertically (top portion) and the lower end of the aperture having a smaller effective diameter than the upper end of the aperture. The major axis for receiving the male shaft when the engagement assembly is in the second position and the smaller diameter axis for when the engagement assembly is in the first position.

The invention further provides a method of fabricating a push button bayonet assembly that includes molding a male member, female housing, female housing face plate and push button engagement assembly out of a polymer, positioning the push button engagement assembly on the female housing, and sonically welding the female housing face plate to the female housing.

These and various features and advantages of the invention will be apparent from a reading of the following detailed description and a review of the appended claims.

### BRIEF DESCRIPTION OF DRAWINGS

FIG. 1 is a perspective view of an uncoupled male member and female member of a push button bayonet in relation to two open-ended tubes in accordance with the present invention.

FIG. 2 is a perspective view of a coupled male member and female member of a push button bayonet in relation to two open-ended tubes in accordance with the present invention.

FIG. 3 is a cross-sectional view along line 3-3 of FIG. 2 of one embodiment of the present invention.

FIG. 4 is a cross-sectional view along line 4-4 of FIG. 2 of one embodiment of the present invention where the push button is biased in an upward position.

FIG. 5 is a cross-sectional view along line 4-4 of FIG. 2 of one embodiment of the present invention where the push button is depressed axially downward.

FIG. 6 is an exploded view of one embodiment of the ring latch-male member engagement in accordance with the present invention.

FIG. 7 is an exploded view of an alternative embodiment of the ring latch-male member engagement in accordance with the present invention.

FIG. 8 is a cross-sectional view along line 7-7 of FIG. 5 of one embodiment of the present invention where the push button ring latch is engaged with the male member.

FIG. 9 is a cross-sectional view along line 7-7 of FIG. 5 of one embodiment of the present invention where the push button ring latch is disengaged from the male member.

FIG. 10 is an exploded perspective view of one embodiment of the push button bayonet of the present invention.

### DETAILED DESCRIPTION OF INVENTION

A push button bayonet assembly for connecting two fluid passageways is provided. The push button bayonet assembly reversibly couples two fluid passageways to each other, one fluid passageway connected to a male member of the assembly and one fluid passageway connected to a female member of the assembly. The male and female members are secured together via physical interference held in position by a spring biased assembly (or other similar biasing force), the force being released by actuation of a push button on the female housing engagement assembly. Operation of the selective connection between the male and female members is fast and convenient. The assembly disclosed in the present invention is used to connect any two fluid passageways together, including passageways that contain pressurized gases or fluids, and is especially adaptable for small scale designs. This invention can be used on tubes having inner diameters of one-sixteenth of an inch or less to tubes having an inner diameter of one-half inch or more. It is believed that embodiments of this invention are especially useful when a lubricant or other material impedes the user's grip. Further, the present bayonet assembly removes any actuation of a collar structure (difficult to manipulate), standard to most bayonet structures, which is replaced by an easily manipulated push button device.

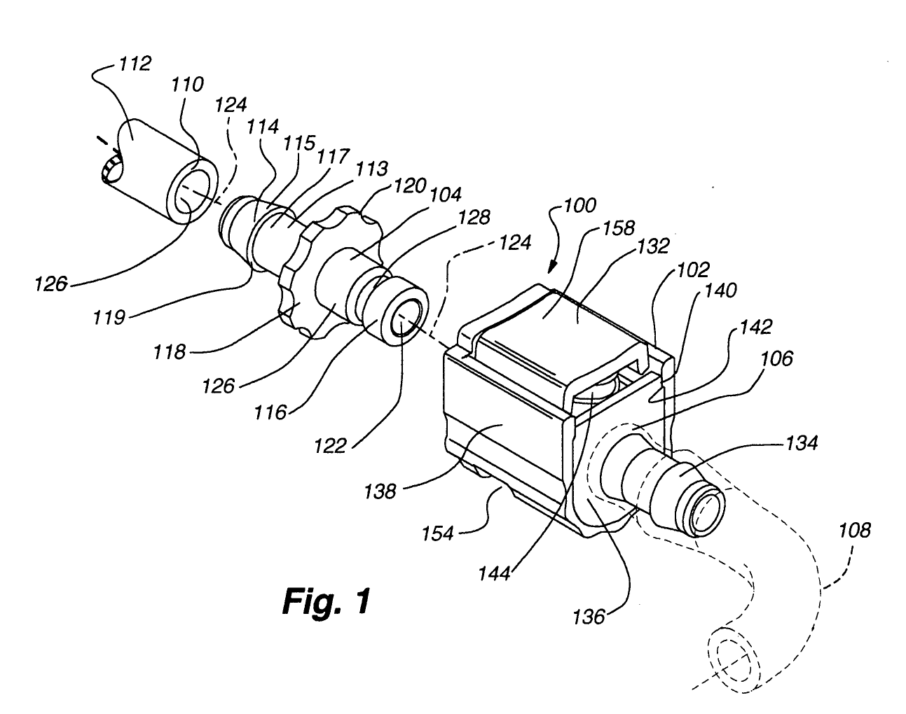

Referring to FIG. 1, one embodiment of a push button bayonet assembly 100 of the present invention is shown. The push button bayonet assembly 100 is positioned for exertion of control over the flow of a fluid within a fluid passageway. The push button bayonet assembly 100 provides a release point within the fluid passageway to disrupt and allow manipulation of the fluid flow within the fluid passageway. The push button bayonet assembly 100 generally includes a female member 102 and a male member 104, the female member 102 releasable receiving the male member 104. The female member 102 coupled to one free end 106 of a first section of tubing 108 and the male structure 104 coupled to one free end 110 of a second section of tubing 112. When the female and male members (102 and 104 respectively) are connected together fluid flow is allowed to pass from the first 108 to the second section of tubing 112; when the female and male members are disconnected, fluid flow is interrupted from passing from the first 108 to the second section of tubing 112.

In more detail, FIG. 1 shows two sections of tubing 108, 112 connected to each other via an embodiment of the push button bayonet assembly 100 of the present invention. The male member 104 of the push button bayonet connection assembly 100 is generally a cylindrical tube 113 having a first barbed end 114 for engagement with an open-end 110 of a section of tubing 112 and a second end 116 for engagement with the female member 102. The first barbed end 114 is composed of a cannula portion 115 shaped as a frustum tapering toward a distal end. The proximal end of the cannula portion 115, larger diameter of the frustum, connects with a coupling shaft 117 of a narrower outer diameter than that of the proximal end of the cannula portion 115. The difference in outer diameters results in an annular shelf that provides a barb 119.

An optional centrally located radial flange 118 provides a surface that can be gripped during manipulation of the male member 104. The radial flange 118 generally extends a sufficient distance away from the cylindrical tube 113 for a user to grip and operatively manipulate the male member 104. The radial flange 118 may include undulations 120 along its radial circumference to facilitate the user's grip.

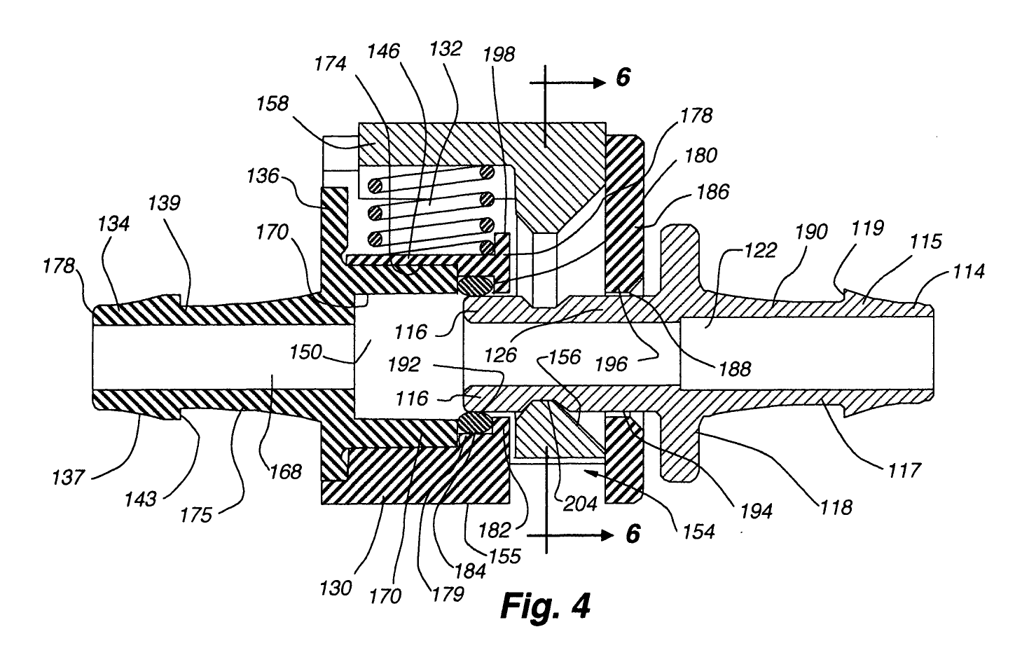

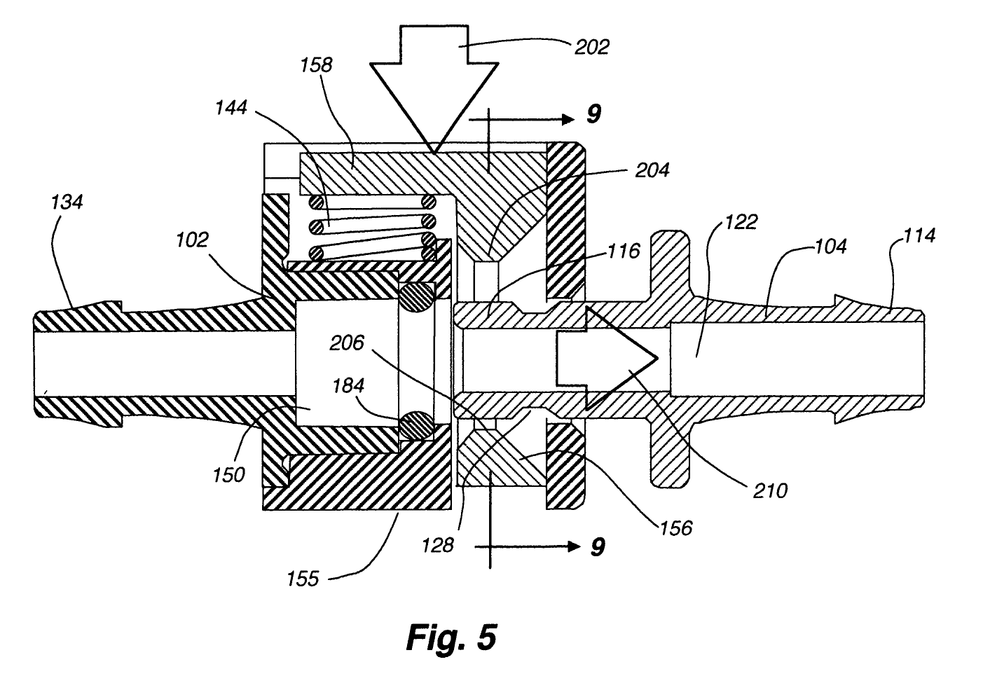

The male member 104 defines an internal channel or passageway 122 that extends between its two ends 114, 116 (see FIGS. 4 and 5). The internal channel 122 is typically aligned (see line 124) with the bore 126 defined by the section of tubing 112 when the first end 114 of the male member 104 is engaged to the tubing 112. The channel may be offset from line 124 if desired. A male portion or shaft 126 of the male member 104 has a circumferential groove 128 formed around it, between the free end 116 of the male member and the radial flange 118. Note that the circumferential groove 128 may completely extend circumferentially around the shaft 126 or may only partially extend circumferentially around the shaft, as will be described in greater detail below.

In one embodiment of the present invention, the female member 102 of the bayonet assembly 100 generally includes a U-shaped housing 130, a spring loaded push button assembly or engagement assembly 132 positioned on the U-shaped housing, and a male barb 134 extending from a face plate 136 positioned at one end of the U-shaped housing 130. The face plate and male barb are position at the opposite end of the female member than that end which receives the male member.

As previously described for the male member barb, the female member male barb 134 includes a cannula portion 137 shaped as a frustum tapering toward a distal end. The proximal end of the cannula portion 137, having a diameter in excess of that for the frustum, connects with a coupling shaft 139 of a narrower outer diameter than that of the proximal end of the cannula portion 137. The difference in outer diameters results in an annular shelf that provides a barb 143.

With regard to the U-shaped housing 130, the two side-walls 138 that define the shape of the U in the U-shaped housing 130 meet to form a lower curved wall 155 giving the housing its U-shape. The side-walls 138 and lower curved wall 155 defining an open channel or cavity within the housing (not seen in FIG. 1). A flange or ledge 140 is located along at least a portion of each of the two-side walls 138, extending inwardly into the open channel. Note that the ledge on each side-wall is essentially the same width and dimension, and is generally positioned toward the upper edge 143 of the U of the U-shaped housing. In preferred embodiments, the ledge is essentially positioned at a same distance below the upper edge of each of the two side-walls. It is envisioned that in some embodiments the ledge extends along the entire length of the U-shaped housing side-walls. Note also that although the present invention is described as having a generally U-shape, other shapes may also be used, including a square shape housing, circular shape housing, etc, which would be formed by the appropriately shaped side-walls and lower wall.

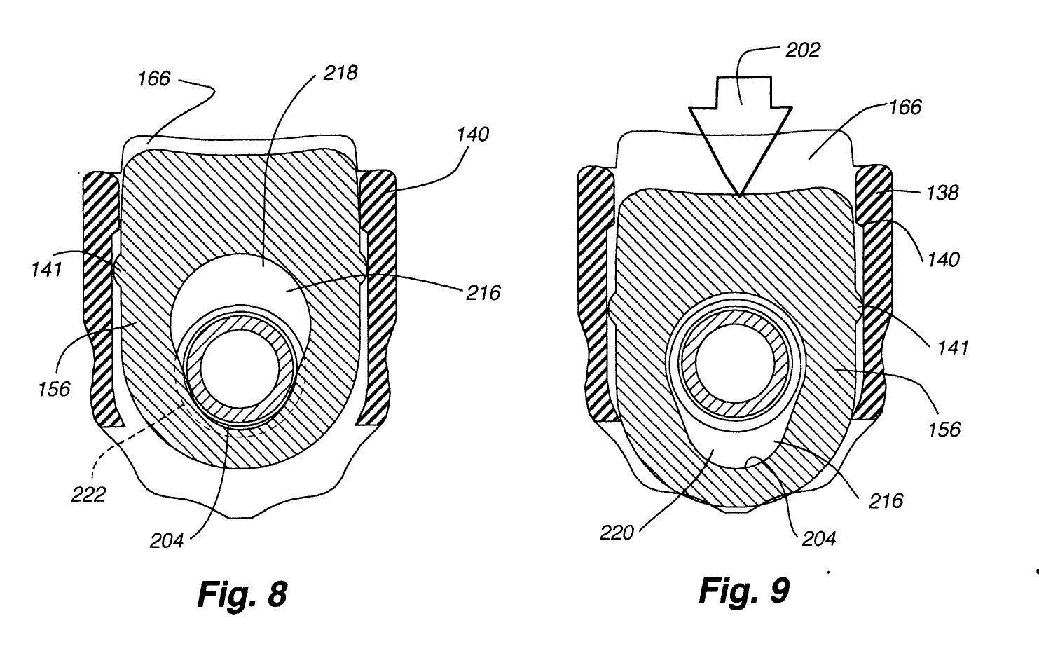

A platform 146 extends across and between the two side-walls 138 of the U-shaped housing 130 to form a centrally located generally circular channel or cavity (see FIG. 8) 150 within the female housing. The top of the platform 152 (see FIG. 3) provides a substantially flat surface which acts as a seat for a spring 144 of the push button assembly 132 (see below for greater detail).

The push button engagement assembly 132 defines a substantially flat thumb plate 158 having a ring latch plate 156 dependent therefrom (best seen in FIGS. 8-10). A wall 157 extends from the ring latch plate 158, adjacent to the side-walls of the U-shaped housing (see also FIG. 4). The thumb plate 158 and ring latch plate 156 are oriented generally perpendicular to each other where one end of the ring latch plate extends from and depends from the front edge of the thumb plate 158. The ring latch 156 moves according to the movement of the push button thumb plate 158.

A slot 154 in the bottom wall 155 of the U-shaped housing provides room for the ring latch 156 (see below and see FIGS. 4, 5, 8 and 10) that depends from the push button plate 158 to move between the first and second position. The slot 154 is of at least a size and dimension to accept the ring-latch without interfering with its movement.

The spring 144 is positioned between the platform 146 that bridges the two side-walls 138 of the U-shaped housing and the underside 148 of the push button thumb plate 158; the spring biasing the push button thumb plate away from and off the platform 146 (see also FIG. 3).

Referring to FIG. 1 and FIGS. 3, 4, 8 and 9, the ring latch has a U-shaped wall structure 157 that defines a pair of legs 140, each leg having a prong 141 extending toward the respective side-wall 138 of the U-shaped housing (seen best in FIG. 3). The prongs 141 engage with the ledge or shelf 140 defined along the side-walls of the U-shaped housing when the push button assembly, i.e., ring latch, is biased by the spring 144 (best viewed in FIGS. 3, 8 and 9) away from platform 146. It is envisioned that other structures could be used to maintain the push button engagement structure 132 within the U-shaped housing when biased by a force, for example, the two-side walls of the U-shaped housing could be thicker at their top edges 143 forming an inwardly sloping engagement face which could interface with corresponding tapered ring latch legs (not shown). Other combinations are also envisioned for this interaction including extension-detent interactions.

The U-shaped housing channel is in fluid communication with the coupler shaft 139 defined within the male barb 134 of the female member. Further, when the female and male members are engaged, the internal channels of the female and male members are generally aligned and in fluid communication with the first and second sections of tubing. Note that although preferable, alignment of the channels within and among the fluid passageways is not requisite to the invention, as long as fluid can pass from one fluid passageway 108 through the bayonet assembly 100, to the other fluid passageway 112. However, it is preferred that channel sizes and design minimize the fluid flow path disruption during its transition across the push button bayonet assembly.

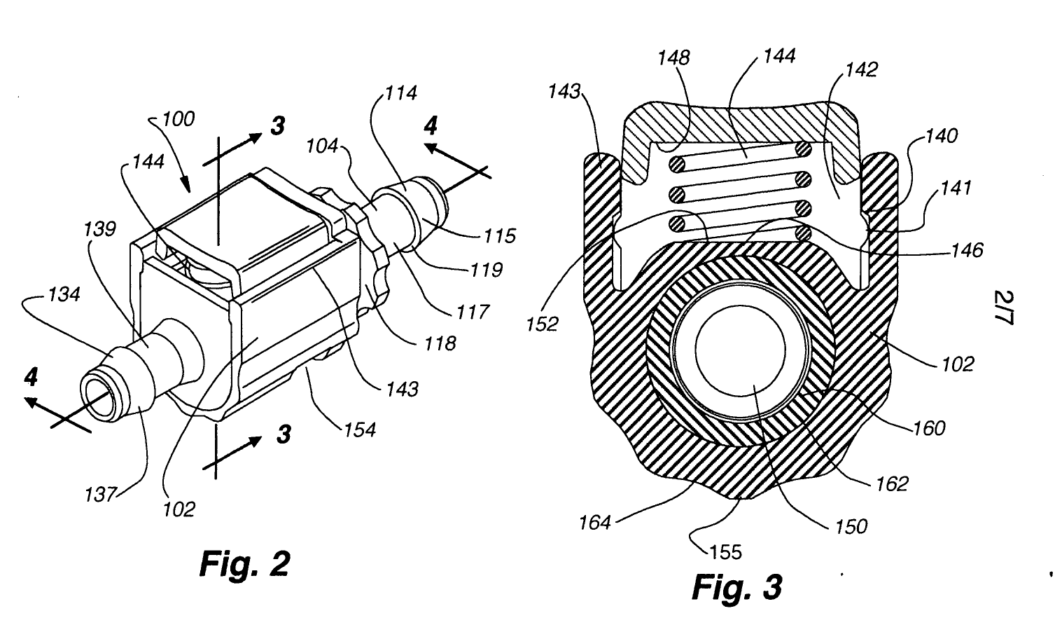

FIG. 2 illustrates the male and female members of the push button bayonet assembly 100 in an engagement position. As noted above, each end of the bayonet assembly 100 has a laterally extending barb 114, 134 for engagement with the two sections of tubing 108, 112. These barbs help secure the ends of the respective tubing sections onto the ends of the male and female members.

The centrally located actuated push button assembly 132 is positioned on the female member 102 for use in selectively engaging the male member 104 to hold it within the female member 102. As described in greater detail below, downward pressure exerted on the push button thumb plate allows the two members of the bayonet assembly to be pulled apart, thereby disconnecting the two sections of tubing from each other. Once separated, the two members 102, 104 may be engaged by either exerting downward pressure on the push button engagement assembly and sliding the second end or shaft 126 of the male member into the receiving end of the U-shaped housing and releasing the push button or simply sliding the shaft 126 of the male member.

FIGS. 3, 4 and 5 show cross-sectional views along lines 3-3 and 4-4 (FIGS. 4 and 5) of FIG. 2.

Referring to FIG. 3, a cross-sectional view along line 3-3 of FIG. 2 of the push button bayonet assembly 100 is shown. FIG. 3 illustrates the positioning of the push button assembly 132 in relation to the U-shaped housing 130. The circular shaped chamber 150 within the female member 102 is shown formed from the side-walls 138 of the U-shaped housing and the platform 146. The wall 160 of the second end of the male member is shown engaged with the interior surface 162 of the chamber 150. Note that in FIG. 3 the non-hatched barbed end of the male member is shown extending out of the page toward the reader. The spring 144 of the push button engagement assembly sits on the top surface 152 of the platform 146 and exerts upward pressure on the bottom surface 148 of the push button thumb plate 158.

The prongs 141 extending from legs 142 may slide along the interior surface of the side-walls 132 of U-shaped housing when the push button is biased away from the platform 146. The ledge 140 provides a stop for movement of the ring latch plate by interacting and preventing further movement by the prongs of legs 142 away from the U-shaped housing. Spring 144 exerts an upward force on the push button plate 158 which is counter-balanced by an engagement between the prongs 141 engaged against the ledge 140 formed along the U-shaped housing side walls 138.

The exterior wall of the U-shaped housing may provide curved indentations 164 for enhanced grip by the user. As is obvious from FIG. 2, the bayonet assembly is compact and easy to manipulate due to its overall shape and grip enhancing features on both the female and male members.

Referring next to FIG. 4, a longitudinal cross-sectional view of the push button bayonet assembly 100 is shown. The U-shaped housing 130 of the female member is shown with U-shaped walls 132 and platform 146 that form the centrally located channel or cavity. The face plate 136 on the female member 102 has a centrally located opening 168 with an inwardly extending wall 170 toward and received by the bottom wall 155 of the U-shaped housing. This extending wall engages the bottom surface 174 of the platform 146 and interior surface of the U-shaped housing walls.

A longitudinally extending connection shaft 175 extends outwardly from the other side of the female housing face plate 136 and is centered over the face plate opening 168. This shaft 175 on the female structure provides the engagement end of the female member with a section of tubing. As described previously, the distal end of the shaft defines an engagement barb 134 that enhances friction between the female member and the tubular walls of most flexible passageways.

A notch 178 is formed at one end of the chamber of the U-shaped housing for receiving an O-ring 184. An engagement surface 179 defined by the ends of the wall 170 extending inwardly from the face plate 136 and an abutment end 180 of an inwardly extending flange 182 from the female housing cavity walls form the notch 178. The notch 178 receives a sealing member 184, e.g., O-ring, or other like structure for sealing with the male member 104 of the assembly when the male member 104 is inserted into the female member 102.

At the male member receiving end of the U-shaped housing, i.e., opposite the end having the male shaft, a second plate 186 extends across the U-shaped walls to enclose the interior of the U-shaped housing. The plate 186 defines a centrally located opening 188 for receiving the second end 116 and shaft 126 of the male member 104.

The cross-sectional view of the male member 104 in FIG. 4 illustrates the barbed end 114 for engagement with a section of tubing, the centrally located radial flange 118 for enhanced grip and manipulation of the male member by a user, and the male shaft 126 of the male member 104 that extends within the U-shaped housing 130 of the female member 102 for engagement with the female member.

The barbed end 114 of the male member 104, like the barbed end 134 of the female member 102, has a generally sloped surface, with the portion of the sloped surface facing the flow passage having a thinner wall than the opposite portion of the barbed wall (see above). As is known, the barb end 114 enhances friction between the male member and the tubular walls of most flexible passageways for a secure attachment and seal.

The portion of the male member 104 not directly engaged within the female housing defines a substantially uniform tube 190 having the radial flange 118 that provides a gripping surface for manipulation of the male member.

The male shaft 126 of the male member is received within the female housing 130. A substantially uniform diameter tube 194 of the male shaft extends through the opening 188 located in the second integral plate 186 of the female housing. The second end 116 of the shaft 126 of the male member defines an engagement surface 192 around the outer circumference of the shaft for engagement with the O-ring 184. The engagement surface 192 of the second end 116 of the male member is generally flat and engages the O-ring 184 positioned inside the female member 102 (and see above). It is also envisioned that the flange 182 of the female housing and engagement surface 192 of the male member could directly engage each other to provide a sufficient seal between the two members of the connection assembly 100 (not shown).

Still referring to FIG. 4 and as briefly described above, the spring loaded push button 132 of the female member defines a flat thumb plate 158 with a dependent ring latch 156. The biasing spring 144 is positioned between the top surface 152 of the U-shaped housing platform 146 and the bottom surface 148 of the push button plate 158. An upward extension of the U-shaped housing walls forms a ridge 198 to position the spring 144 in between the housing platform 146 and the push button plate.

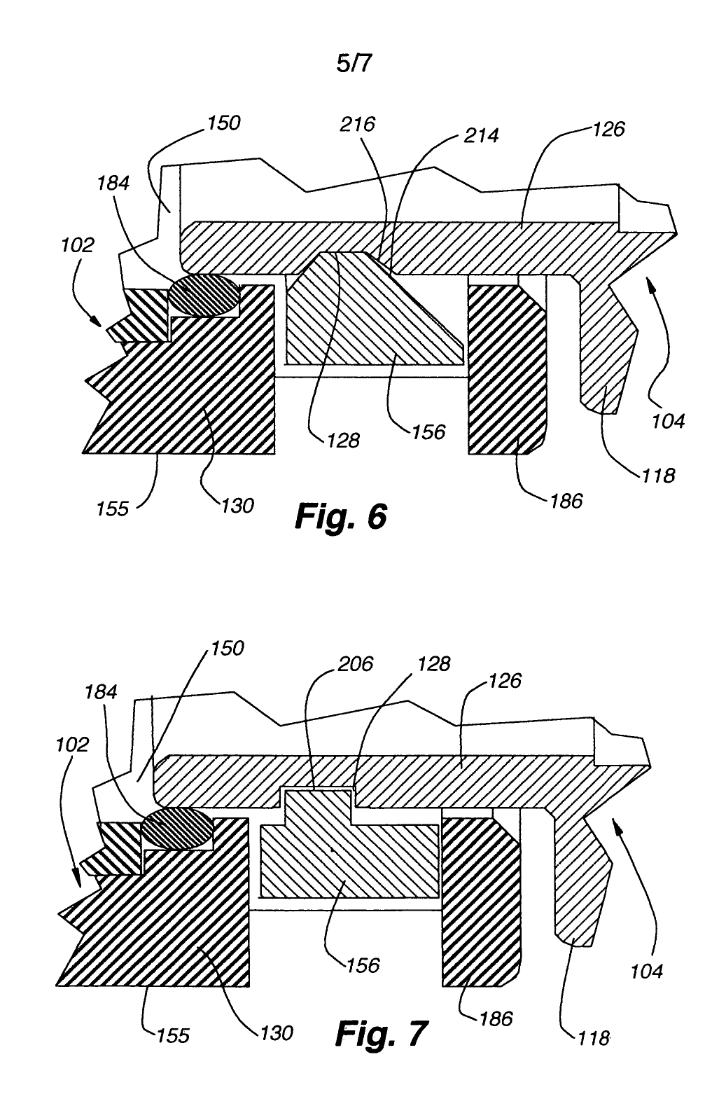

The ring latch plate 156 defines an opening 200 that receives the second end 116 of the male member so that the second end of the male member is retained and extends through the opening 200 of the ring latch plate (see FIGS. 6-10). Actuation of the push button thumb plate 158 causes the ring latch plate 156 to move from a first upwardly biased position to a second position. The male member is in an unlocked position relative to the female member, as discussed in greater detail below, when the push button assembly is in the second position.

Referring to FIGS. 4 and 5, FIG. 4 shows the cross-sectional view of a push button bayonet assembly 100 in an engaged position. The female and male members are connected via an upward biasing force exerted through the ring latch plate on the male shaft of the male member. FIG. 5 shows the same view with actuation of the push button thumb plate 158 downwardly, see arrow 202, and release of the male member 104 from the female member 102. In the engaged or locked position the push button ring latch 156 of the female member sits within the groove 128 formed around the tubular shaft at the second end 116 of the male member. The cross-sectional width of the ring latch wall 204 and depth and width of the groove 128 substantially match to maximize engagement surfaces to keep the male member trapped within the female member. The spring 144 exerts an upward force on the push button thumb plate 158 and thereby exerts an upward force on the ring latch which pushes the curved edge or wall 204 into the groove 128, thereby retaining the male member within the female member. Forces applied, see arrow 210, to retract the male 104 from the female 102 member while the ring latch 156 is retained within the groove 128 are resisted by the edge of the ring latch and the walls of the groove (FIG. 5). When the edge of the ring latch is not engaged with the walls of the groove, force 210 applied to remove the male member from the female member is not resisted, and the two members may be pulled apart and disconnected.

In an alternative embodiment of the ring latch edge to groove interaction, as shown in FIG. 7, the inner edge 206 of the ring latch 156 is planar and the groove 128 in the second end of the male member is squared to receive the ring latch wall. As such, movement of the male member from the female member, or conversely movement of the male member into the female member for locking position, is accomplished when the push button is actuated to completely remove the ring latch edge from the groove thereby freeing the two members from each other. This embodiment is preferable where fluid pressures or fluid types transported across the bayonet assembly are more at issue as the planar wall interaction with the square groove provide a highly secure interaction requiring full removal of the planar wall from the groove prior to any movement.

In more detail with regard to the ring latch to groove interaction shown in FIGS. 4 and 5, as shown in FIG. 6, the wall 212 of the ring latch 156 is sloped to form a cam surface edge 214 that is matched by a slope 216 formed in the groove in the male member. The sloped surfaces 216 allow the male member 104 to slide into and out of position within the female housing when sufficient longitudinal pressure is exerted to the engagement without activation of the thumb plate, i.e., the surfaces will provide resistance which is overcome as the two surfaces slide along each others slopes. Note also that the groove formed in the female U-shaped housing provides the space necessary for the ring latch to move in the downward direction without being inhibited by the bottom portion 155 of the U-shaped wall via slot 154.

With regard to this ring latch plate-groove interaction, it is also envisioned that the edge 214 of the ring latch and groove surfaces 216 of the male shaft define one surface, typically the surface away from the first end of the male member, as planar while the other end remain sloped. As can be imagined, alternative shapes of the ring latch edge to groove interaction can be used in relation to the present invention, as long as the interaction is sufficient to perform the functions of the push button assembly of the present invention. For example, instead of an edge structure on the ring latch, a series of prongs or other extensions could extend away from the ring latch to interact with corresponding holes or detents formed around the circumference of the male member shaft.

Referring again to FIG. 5, movement of the push button thumb plate 158 in the downward direction (arrow 202) causes compression of the spring 144 and movement of the ring latch edge 204, 206, 214 from the male member groove 128. The male member is being moved out of the U-shaped female housing (see arrow 210), thereby allowing the O-ring 184 to decompress.

FIGS. 8 and 9 show a cross-sectional view along line 8-8 and 9-9 of FIGS. 4 and 5 respectively. FIG. 8 illustrates the position of the ring latch 156 in relation to the male member 104 in a locked position. FIG. 9 illustrates the position of the male member 104 in relation to the ring latch 156 in an unlocked position. In more detail, the ring latch 156 depends from the end of the thumb plate 158 adjacent the U-shaped housing second plate 166 and extends toward the slot 154 formed in the bottom wall of the U-shaped housing. Centrally located in the ring plate is a teardrop opening 216 for receiving the second end 116 of the male member. The teardrop opening 216 has two diameter openings, a larger diameter opening (having a major axis) 218 at the top portion that gives way to a smaller diameter (minor axis) opening 220 at the bottom portion. The teardrop openings are precisely shaped to account for the movement of the ring latch in relation to the male member, and in particular movement of the inner edge 204 (note that inner edge embodiments 206 and 214) of the ring latch 156 within the lower opening 220 of the teardrop in relation to the groove 128 of the male member 104. In one embodiment, the larger diameter opening and smaller diameter opening are related via the relational angle of 1/8 inch of vertical change equals X change in diameter of the opening.

In general, the dimensions of the teardrop openings 218, 220 are determined by the outer circumference of the tubular wall 194 of the second end 116 of the male member in relation to the circumference of the groove 128 formed in the tubular wall of the second end of the male member. In the closed or locked position, the ring latch 156 is biased upwardly to force the upper edge 204 of the smaller diameter opening 220 of the ring latch against the inner wall of the groove. The dashed line 222 in FIG. 8 shows the actual surface of the second end 116 of the male member as it sits around the ring latch edge 204. Depression of the thumb plate in FIG. 9 shows the ring latch moving over the second end of the male member, thereby moving the ring latch edge 204 out of the groove 128 and the male member into the larger diameter portion 218 of the teardrop opening. In FIG. 9, the male member 104 is no longer engaged with the female member 102 and the two members can be longitudinally or axially moved relative to one another.

It is also envisioned that the ring latch plate define an opening having only a single diameter, where the edge defined by this opening would engage a substantial portion of the groove around the circumference of the male member, to perform the function of the push button assembly (not shown). The single opening could be designed to have a diameter slightly larger than the outer diameter of the male shaft, so that the ring latch could receive the male member but still provide for a sufficient interaction with the groove.

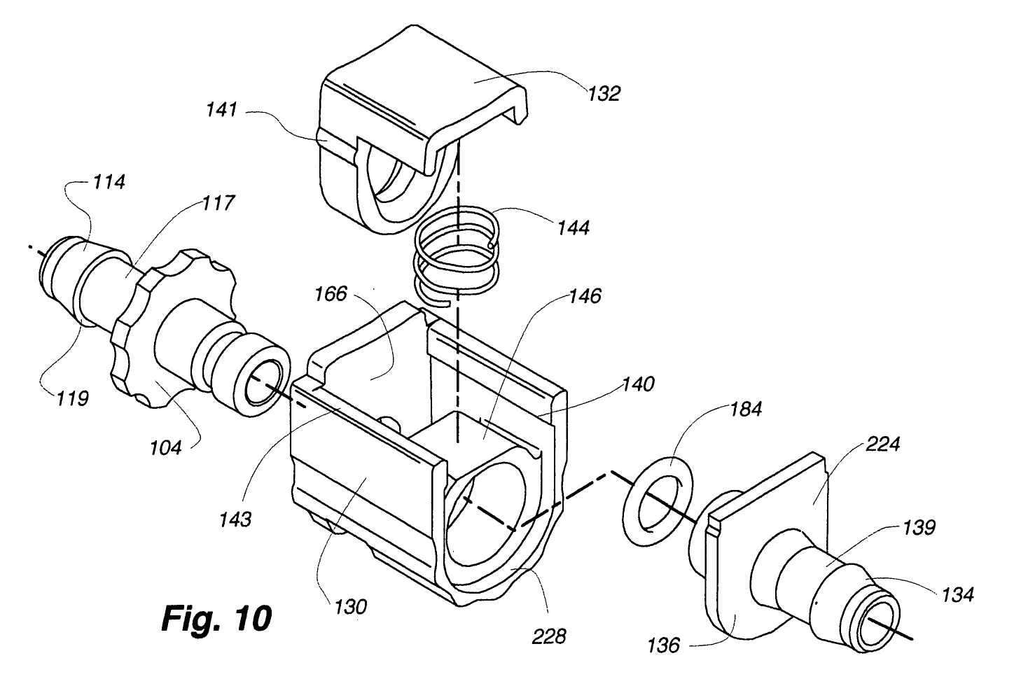

FIG. 10 provides an exploded perspective view of the push button bayonet assembly 100 of the present invention. In preferred embodiments, the bayonet assembly 100 is fabricated from a series of four molded pieces: the male member 104, the U-shaped female housing 130, the push button assembly 132, and the female face plate with “male” connector extension portion 224. A spring 144 and sealing member 184 form the remaining pieces of the bayonet assembly 100. Each of the four molded pieces 104, 130, 132, 224 can be formed from a polymer material, for example a thermoplastic polymer or other like substance. Suitable polymers would include ABS, nylon, polypropylene, or they could be made out of metal, ceramic or any other structural material.

In use with respect to bayonet assembly 100 fabrication, the O-ring 184 is positioned within the notch 178 of the U-shaped housing 130 (abutting the downwardly extending U-shaped wall flange). The spring 144 is positioned on the housing platform 146 and the push button 132 is positioned on the spring with laterally extending protrusions or prongs 141 slipped under the U-shaped housing wall shelf 140. The female housing face plate 136 is positioned along an engagement surface 228 formed by the side and bottom walls of the U-shaped housing. Standard sonic welding techniques are used to fixedly attach and position the face plate 136 on the U-shaped housing, including along the extending wall that engages the exterior surface of the U-shaped housing cavity. It could be attached in numerous ways, including by adhesive or other means. In this manner the O-ring and biased push button are secured in the female member.

The male and female barbs 114, 134 for attaching the ends of the assembly to the respective tube sections could instead be, without limitation, threaded, press-fit, panel-mount, or any other type of connector structure for attachment to a tube member.

It is understood for purposes of this disclosure, that various changes and modifications may be made to the invention that are well within the scope of the invention. Numerous other changes may be made which will readily suggest themselves to those skilled in the art and which are encompassed in the spirit of the invention disclosed herein and as defined in the appended claims.

In this upwardly biased position (or first position), the ring latch 156 of the push button 132 engages within the groove 128 of the male shaft 126 of the male member to connect the female member 102 to the male member 104 (as is described in greater detail below and see FIGS. 6 and 7).

Various modifications, equivalent processes, as well as numerous structures to which the present invention may be applicable and will be readily apparent to those of skill in the art to the present invention, which are considered within the scope of the disclosure.

1. A push button bayonet assembly for connecting a first section of tubing with a second section of tubing, the push button bayonet assembly comprising:
a female member comprising a female housing having a channel extending therethrough, the female housing further comprising a push button engagement assembly, the push button engagement assembly comprising a top platform portion and a dependent ring latch portion defining an aperture, the engagement assembly movable between a first position and a second position, and biased in the first position; and
a male member having a connector shaft having a groove extending at least partially circumferentially around the shaft;
wherein the ring latch aperture receives the male member shaft when the engagement assembly is in the second position, and the ring latch engages the groove in the first position to retain the shaft in the channel.

2. The push button bayonet assembly as defined in claim 1, wherein the ring latch aperture has a major axis oriented vertically for receiving the male member shaft when the engagement assembly is in the second position and a lower end of the aperture having a smaller effective diameter than the upper end of the aperture for receiving the male member of the shaft when the engagement assembly is in the first position.

3. The push button bayonet assembly as defined in claim 1, wherein the ring latch further defines a pair of laterally extending prongs and the female housing further defines a U-shaped wall having an inwardly facing surface, the inwardly facing surface having a ledge for interaction with the ring latch prongs when the push button engagement assembly is in the first position.

4. The push button bayonet assembly as defined in claim 1, wherein the male member further comprises a radial flange extending from the shaft, the radial flange not positionable within the female housing, wherein the radial flange provides enhanced manipulation of the male member when moving the male member into and out of the female housing.

5. The push button bayonet assembly as defined in claim 1, wherein the female housing has a barbed end for engagement with the first section of tubing and the male member has a barbed end for engagement with the second section of tubing.

6. The push button bayonet assembly as defined in claim 1, wherein the female housing is U-shaped and defines a slot positioned axially from the ring latch for receiving the ring latch when the push button engagement assembly is in the second position.

7. The push button bayonet assembly as defined in claim 1, further comprising a sealing member positioned within the female housing, an end of the male member shaft received within the female housing defines an engagement surface, wherein the engagement surface forms a seal with the sealing member when the push button engagement assembly is in the first position.

8. The push button bayonet assembly of claim 1, wherein the ring latch aperture has a tear-drop shape and wherein a first diameter opening of the aperture receives the male member shaft when the push button engagement assembly is in a first position and is received by a second diameter opening when the engagement assembly is in a second position.

9. The push button bayonet assembly of claim 1, wherein the biasing force retaining the male member shaft in the ring latch is exerted by a spring.

10. The push button bayonet assembly of claim 9, wherein the spring is compressed between the push button engagement assembly and the female housing to move the push button engagement assembly from the first position to the second position.

11. The push button bayonet assembly of claim 10, wherein the female housing is substantially U-shaped having a housing platform that extends between a first sidewall and a second sidewall of the U-shaped housing, the housing platform and U-shaped housing walls forming a channel and wherein the spring is compressed between the push button engagement assembly and the housing platform.

12. A method for fabricating a push button bayonet assembly, the method comprising:
molding, out of polymer, a male member having a barbed end for receiving a first section of tubing, a U-shaped female housing having an internal notch for receiving a sealing member, a female housing face plate with barbed end for receiving a second section of tubing, and a push button engagement assembly;
positioning a sealing member within the notch of the female housing;
positioning a spring between the push button engagement assembly and the female housing; and
sonically welding the female housing face plate to the female housing, the barbed end of the female housing face plate extending away from the female housing.

13. The method of claim 11 wherein the polymer is a thermoplastic polymer.
